(19) United States
(12) Patent Application Publication
(10) Pub. No.: US 2003/0090169 A1
(43) Pub. Date: May 15, 2003

(54) Stator for electric motors

(76) Inventor: Hans Schogler, Fehring (AT)

Correspondence Address: Collard & Roe, 1077 Northern Boulevard, Roslyn, NY, 11576-1696, US

(21) Appl. No.: 10/258,778

(22) PCT Filed: Apr. 19, 2001
(86) PCT No.: PCT/AT01/00120

(30) Foreign Application Priority Data
Apr. 27, 2000 (AT) A 736/2000

(51) Int. Cl. H02K 1/12

(52) U.S. Cl. 310/259

(57) ABSTRACT

The invention relates to a stator (1) for electric motors, especially for use in hermetically encapsulated refrigeration machines, comprising stator windings (4a, 4b) and a lamellar structure, the individual lamellae (2) being kept together by fastening means (8). The aim of the invention is to provide an electric motor, especially for use in hermetically encapsulated refrigeration machines, which is characterized by a substantially reduced noise during operation of the electric motor as compared with conventional stators. To this end, pressure means (14, 15, 20) are provided on at least one front face (3a, 3b) of the stator (1) between the fastening means (8), said pressure means exerting a pressure on the lamellar body (2) of the stator (1).

The present invention relates to a stator for electric motors according to the preamble of claim 1.

Such electric motors are used for example in refrigerators in order to drive the piston of a compressor which compresses the refrigerant.

A frequently occurring problem are the vibrations and jolts which are caused by the compressor and which are disturbing for the consumer.

It has now been found that a part of the occurring noise level is produced or caused by the stator of the electric motor. The lamellae-like arrangement of a stator presumably contributes to this noise development because it concerns a relatively loose structure that that can be made to oscillate very easily.

No measures are known from the state of the art which counteract the aforementioned noise development in a purposeful manner.

It is therefore the object of the present invention to provide a stator for an electric motor, especially for use in hermetically encapsulated refrigerating machines, which is characterized in comparison with conventional stators by a substantially lower noise development during the operation of the electric motor.

This is achieved in accordance with the invention by the characterizing features of claim 1.

It was surprisingly noticed that by exerting a pressure on the lamellae body of the stator it is possible to substantially reduce the noise level in many frequency regions. The pressure can be applied optionally to a face side of the stator or to both sides simultaneously. Every single measure reduces the noise level.

An especially high noise reduction can be achieved according to the features of claims 2 and 3.

As a result of the measures of claims 4 and 5 it is not necessary to install any additional components for achieving the noise reduction. Instead, the goal can be achieved in a very simple way with the existing components. Through such measures it is also possible to considerably improve stators that are already in use or have already been manufactured.

The features of claim 6 ensure that the pressure on the lamellae body of the stator is increased, which also leads to an optimization of the noise reduction.

The features of claim 7 produce a further stiffening of the lamellae body of the stator, which again has a positive effect on the noise development.

Claims 8 and 9 describe an alternative embodiment of a stator in accordance with the invention, with merely one or two additional components being required in this case as well.

The features of claim 10 allow a variable adjustment of the pressure which is exerted on the lamellae body of the stator.

Claims 11 and 14 describe a method in accordance with the invention for reducing the noise level of stators of electric motors according to claim 1.

The features of claims 15 to 17 describe an apparatus for producing a bend-up in accordance with the invention of the lamellae of the lamellae body 2 of stator 1.

Below there is a detailed description of a stator in accordance with the invention on the basis of embodiments, wherein:

FIG. 1 shows a side view of a stator in accordance with the invention with a bent-up uppermost lamella or with a support plus bore;

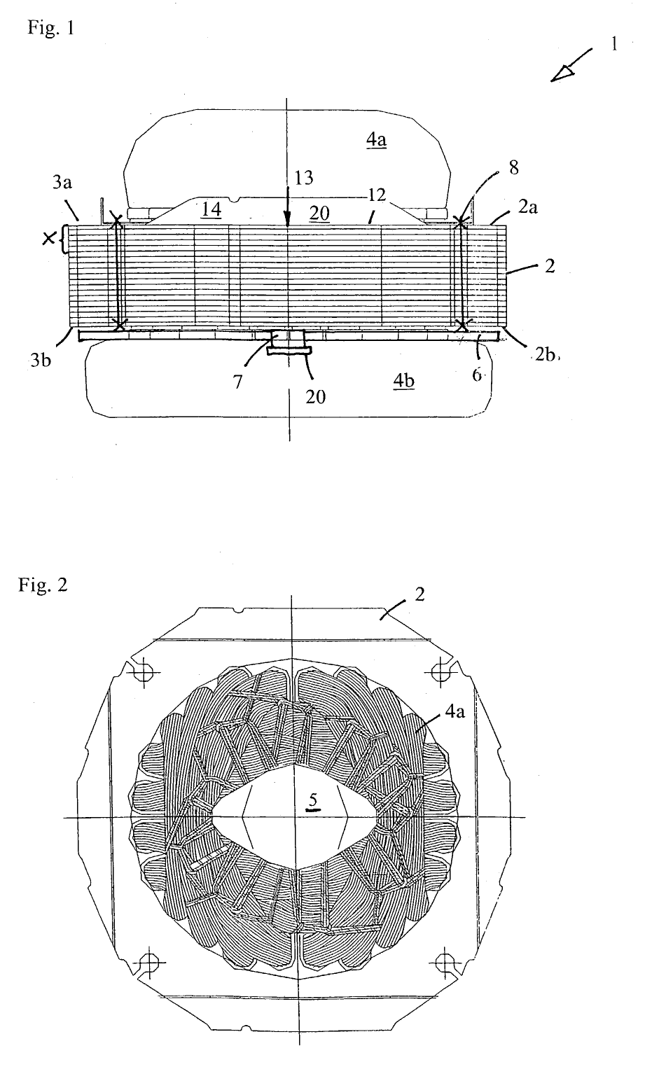

FIG. 2 shows a top view of a stator in accordance with the invention with a bent-up uppermost lamella;

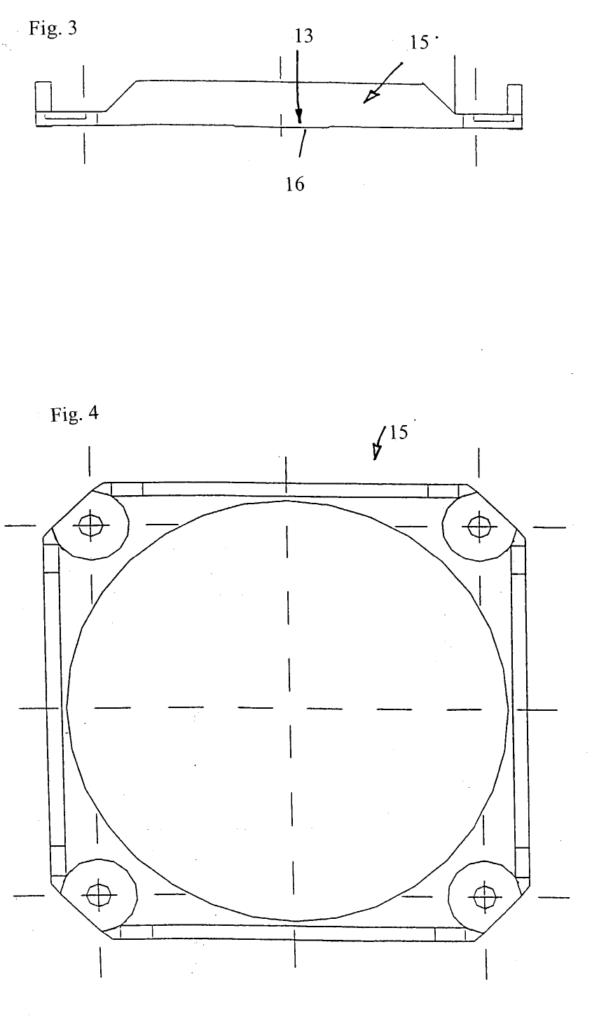

FIG. 3 shows a side view of an annular reinforcing component.

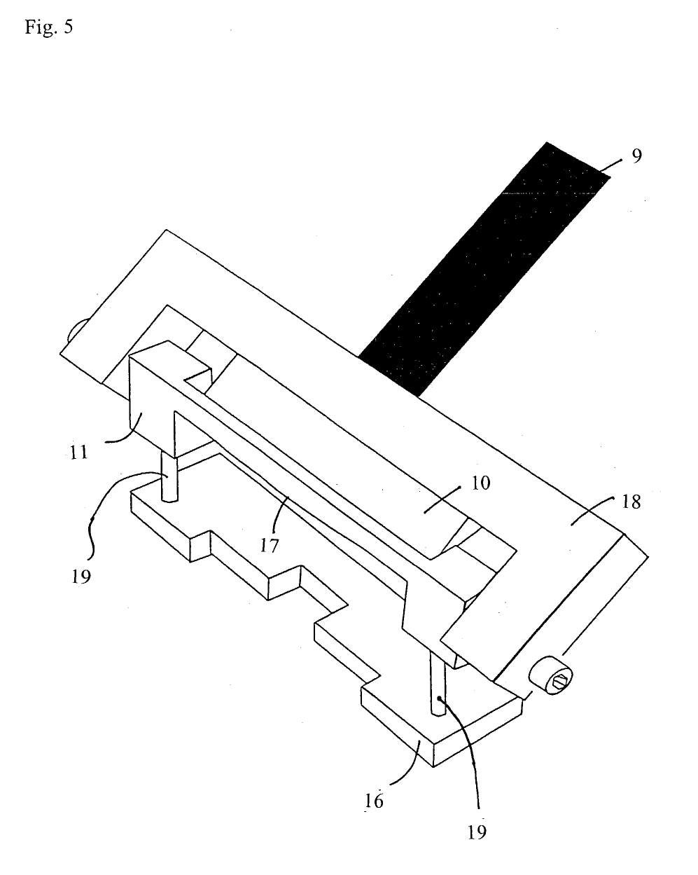

FIG. 4 shows a top view of an annular reinforcing component.

FIG. 5 shows an axonometric view of an apparatus for bending up.

FIGS. 1 and 2 show a stator 1 in accordance with the invention with a bent-up uppermost lamella 2a. Stator 1 comprises a lamellae body 2. The winding heads 4a, 4b of the stator winding are formed on the face sides 3a, 3b of stator 1. The stator bore 5 is provided for receiving a rotor for driving the piston of the compressor (not shown).

The individual lamellae which form the lamellae body 2 of stator 1 are aligned and fixedly connected with each other by fastening means 8 (only shown schematically). The fastening means 8 are usually a conventional screw-and-nut combination. The one end zones of the screws are provided with protective caps and the other end zones with spring bolts which support the stator and also the electric motor with respect to the compressor housing (not shown). The individual lamellae are pressed against each other in the zone of the screws 8 by tightening the screws/nuts. At the same time, the middle region of the lamellae between the fastening means 8 bulges upwardly.

In order to prevent this, the face-side lamella 2a is bent up. Optionally, a second face-side lamella 2b could be bent up. In the latter case the silencing is even more efficient.

The bending up occurs by a special apparatus for bending up (see FIG. 5). The bend-up apparatus essentially consists of a handle 9, a bending part 10 insertable between a lamella to be bent up (such as lamella 2a) and a lamella adjacent thereto, a brace part 11 which comprises a bending edge 17 and cooperates with the same, as well as a clamping member 16 which allows placing the bend-up apparatus on the lamellae body 2, with at least a part of the lamellae body 2 being clamped between the clamping member 16 and the brace part 11. The brace part 11 comprises, as was already mentioned, a bending edge 17 which has the shape as described above of the bending edge 12 finally formed on the bent-up lamella 2a. The handle 9 is arranged in a frame 18 which rotatably connects the bending part 10 with the brace part 17. Brace part 11 and clamping member 16 are mutually connected by screws 19. By changing the length of the screw it is possible to adjust this distance to the size of the lamellae body 2 which is clamped between the brace part 11 and the clamping member 16.

Bending part 10 and brace part 11 are swivelable about at least an angle of 90° in order to achieve an optimal bend-up.

The bend-up apparatus is moved towards the stator 1 in such a way that the bending part 10 is introduced between the lamella (e.g. lamella 2a) to be bent up and the next following lamella. The bending part 10 is designed for this purpose in a respectively wedge-like manner. The bending edge 17 of the brace part 11 is situated on the side of the lamella (e.g. 2a) to be bent up which is opposite to the bending part 10. At the same time the lamellae body 2 of stator 1 is clamped between brace part 11 and the clamping member 16. Thereafter the bending part 10 is also rotated by the rotation of the handle 9, with the lamella to be bent up being bent over the bending edge 17 of the brace part 11. The bracing of the lamellae body 2 between the brace part 11 and the clamping part 16 guarantees a precisely formed bending edge 12 on the bent-up lamella 2a.

The special arrangement of the bending edge 17 ensures, as was already mentioned, that the highest pressure is exerted on the lamellae body 2 in the middle between the fastening means 8.

Instead of merely bending up the uppermost lamella 2 it would also be possible to simultaneously bend up several lamellae X simultaneously.

As a result of bending merely one face-side lamella it was possible to reduce the vibration level in the zone of the bent-up lamella in relevant frequency regions by 10 dB. An even higher noise reduction can be achieved by additional inventive measures, as proposed above.

FIG. 1 further shows an alternative solution of a stator in accordance with the invention in the zone of the face side 3b of stator 1. A support 6 is disposed between the fastening means 8, which support comprises at least one continuous threaded bore 7 and is preferably fixed to the fastening means 8. Said threaded bore 7 is provided for screwing in a screw 20 which exerts the pressure on the lamellae body 2 of stator 1. Depending on the tightness of the screw 20 it is possible to vary the pressure in a simple way. The position of the threaded bore 7 on the support 6 allows choosing the place of introduction of the pressure into the lamellae body 2.

FIGS. 3 and 4 show an alternative solution in accordance with the invention. The pressure on the lamellae body 2 of stator 1 is exerted in this case by an annular reinforcing component 15 (also see FIG. 5) which is fastened to the lamellae body 2 by means of the fastening means 8. The sections between the fastening means 8 are bent up and are provided with at least one extension 16 which faces in the direction of arrow 13 in the installed state of the reinforcing component 15. Alternatively, the sections can comprise respective similarly aligned bulgings in order to further increase the pressure on the lamellae body.

1. A stator (1) for electric motors for compressors, especially in hermetically encapsulated refrigerating machines, with stator windings (4a, 4b) and a lamellae-like arrangement, with the individual lamellae (2) being held together by means of fastening means (8), characterized in that pressure means (14, 15, 20) are provided between the fastening means (8) on at least one face side of the stator (1), which pressure means exert pressure on the lamellae body (2) of the stator.

2. A stator (1) as claimed in claim 1, characterized in that the pressure means (14, 15, 20) exert the pressure on the lamellae body (2) substantially parallel to the rotational axis of the stator (1).

3. A stator (1) as claimed in claim 1 and 2, characterized in that the pressure means (14, 15, 20) exert the pressure on the lameliae body (2) substantially in the middle between the fastening means (8).

4. A stator (1) as claimed in claim 1 to 3, characterized in that the pressure means (14, 15, 20) are the respective lamellae (2a, 2b, 14) of the stator (1) which close off on the face side.

5. A stator (1) as claimed in one of the claims 1 to 4, characterized in that the lamellae (2a, 2, 14) which close off on the face side are bent up between the fastening means (8).

6. A stator (1) as claimed in claim 5, characterized in that the bending edge (12) and the bent-up face-side lamellae (2a, 2b) is bent in the mounted state at least in its middle zone (21) in the direction towards the respective other lamellae.

7. A stator (1) as claimed in one of the claims 5 and 6, characterized in that in addition to the respective face-side lamellae (2a, 2b) lamellae (X) which are adjacent thereto are bent up in a similar manner.

8. A stator (1) as claimed in claim 1 to 3, characterized in that the pressure means (14, 15) are the sections of an annular reinforcing component (15) which are disposed between the fastening means (8), which reinforcing component is arranged concentrically by means of the fastening means (8) on the respective face-side lamellae (2a, 2b) of the stator (1).

9. A stator (1) as claimed in claim 8, characterized in that the sections of the reinforcing component (15) which are arranged between the fastening means (8) are bent up.

10. A stator as claimed in claim 1 to 3, characterized in that the pressure means (14, 15) are screws which can be screwed against the respective face-side lamella (2a, 2b) through at least one support (6) which comprises at least one threaded bore (7) and is disposed between the fastening means (8).

11. A method for reducing the noise level of an electric motor during the operation of a compressor in hermetically encapsulated refrigerating machines, characterized in that during the operation of the electric motor a pressure is exerted on the lamellae body (2) of the stator which compresses the lamellae.

12. A method as claimed in claim 11, characterized in that the pressure on at least one face-side lamella (2a, 2b) is applied at different locations.

13. A method as claimed in claim 11 and 12, characterized in that the pressure is exerted substantially parallel to the rotational axis of the stator (1).

14. A method as claimed in claims 11 to 13, characterized in that the pressure is applied substantially centrally on at least one face-side lamella (2a, 2b) between the fastening means (8) holding the individual lamellae of the stator (1).

15. An apparatus for bending up a stator lamella (2a, 2b) as claimed in one of the claims 4 to 6, characterized in that it comprises the following parts:
a bending part (10) to be introduced between a lamella to be bent up and one adjacent thereto;
a brace part (11) cooperating with the same and comprising a bending edge (17);
a clamping member (16) which allows placing the bend-up apparatus on the lamellae body (2), with at least a part of the lamellae body (2) being clamped between the brace part and the clamping member (16).

16. An apparatus as claimed in claim 15, characterized in that a handle (9) is additionally provided.

17. An apparatus as claimed in claim 15, characterized in that the brace part (11) and the bending part (10) are mutually swivelable about at least 90°.

18. An apparatus as claimed in one of the claims 15 to 17, characterized in that the brace part (11) and the clamping member (16) are connected by means of fastening elements (19) which are adjustable in their length.

19. An apparatus as claimed in claim 18, characterized in that the fastening elements (19) are screws.

20. An apparatus as claimed in one of the claims 15 to 19, characterized in that the bending edge (17) is bulged.

21. An apparatus as claimed in one of the claims 15 to 20, characterized in that the bending edge (17) comprises at least one extension deviating from the straight line.
